(19) United States
(12) Patent Application Publication
(10) Pub. No.: US 2016/0306901 A1
(43) Pub. Date: Oct. 20, 2016

(54) IMPROVEMENTS IN OR RELATING TO THE BUILDING OF SUPPORTS IN ADDITIVE MANUFACTURING

(71) Applicant: RENISHAW PLC, Wotton-under-Edge, Gloucestershire (GB)

(72) Inventors: Iain AINSWORTH, Rudgeway (GB); Geoffrey David RAYNER, Dursley (GB); Michael Joseph MCCLELLAND, Stoke-on-Trent (GB); Ramkumar REVANUR, Eccleshall (GB); Ben Ian FERRAR, Stoke-on-Trent (GB)

(73) Assignee: RENISHAW PLC, Wotton-under-Edge, Gloucestershire (GB)

(21) Appl. No.: 15/103,028

(22) PCT Filed: Dec. 16, 2014
(86) PCT No.: PCT/GB2014/053704

§ 371 Date: Jun. 9, 2016

(30) Foreign Application Priority Data
Dec. 17, 2013 (IN) 3683/DEL/2013
Jan. 28, 2014 (EP) 14275016.5

(51) Int. Cl. G06F 17/50; B33Y 50/00; B29C 67/00

(52) U.S. Cl. CPC G06F 17/50; B29C 67/0088; B29C 67/0092; B33Y 50/00

(57) ABSTRACT

A method and apparatus for generating geometric data are to be used in the building of an object using a layer-by-layer additive manufacturing process. The method includes providing object data defining the object, identifying from the object data one or more regions of a surface of the object to be supported during the additive manufacturing process and, for the or each region, identifying one or more supporting structures that will provide support for the region and generating an arrangement of supports within the region. A support location of each support of the arrangement relative to the other supports of the arrangement is derived from a location of the supporting structures.

### SUMMARY OF INVENTION

This invention concerns improvements in or relating to the building of supports in additive manufacturing where an object is manufactured layer-by-layer by solidification of material by an energy beam, such as a laser or electron beam.

### BACKGROUND

In additive manufacturing processes, such as selective laser melting (SLM) or selective laser sintering (SLS), objects are built layer-by-layer by consolidation of a material, such as powder material, using a focussed high energy beam, such as a laser beam or electron beam. In SLM or SLS, successive layers of powder are deposited on to a build platform and a focussed laser beam scanned across portions of each layer corresponding to a cross-section of the object being constructed such that the powder at the points the laser scans are consolidated. In order to anchor the object in place and to prevent or at least reduce deformations of the object, such as curling, during the build, it is known to build supports of the same material extending from the build platform to the under-surfaces of the object. In order to facilitate removal of the object from the supports after the object has been built, it is desirable to keep the number of supports to a minimum. However, the use of too few supports or inappropriately located supports will result in deformations of the object.

It is known to build supports in predefined patterns, such as a set of equally spaced longitudinal supports extending below the object. An example of such an arrangement is disclosed in U.S. Pat. No. 5,943,235, wherein regions deemed to require support are filled with a set pattern of supports. A pattern of supports is applied to each layer in a region defined by a difference between total data, determined from the Boolean union of the object data for all layers above a given layer, and the object data for that given layer.

AutoFab sold by Marcam Engineering is software that automatically designs supports for an object to be built in an additive manufacturing process. The software can generate substantially continuous supports 1 around edges of a region 3 to be supported (so called “edge supports”) and fill in the region between with a set pattern of supports 2 (so called “area supports”), as shown in FIG. 1. In AutoFab, when supports 1, 2 are constrained to be straight lines, for regions with curved edges, the edge support 1 may comprise small gaps between each support 1. It is also possible to space the edge supports 1 inwards from the edge by a specified distance, as shown in FIG. 2 or to provide cylindrical supports, as shown in FIG. 3.

It is desirable to support a region 3 with the minimum number of supports required to adequately support the region 3 because, the greater the number of supports, the harder it will be to separate the object from the supports at the end of the build. Use of substantially continuous edge supports 1 and/or flood filling a centre of the region with a set pattern of supports 2 does not attempt to optimise the number of supports required for supporting a region. In particular, a substantially continuous support 1 around an edge of the region may provide more support for the edge than necessary. Furthermore, the pattern of area supports 2 may provide supports that are closer to an edge for some areas of the region (such as area A) than for other areas of the region (such as area B). Accordingly, setting the spacing of the pattern of the area supports such that the flood supports adequately support all areas of the region may result in more than enough supports for supporting some areas of the region (such as area A).

### SUMMARY OF THE INVENTION

According to a first aspect of the invention there is provided a method of generating geometric data to be used in the building of an object using a layer-by-layer additive manufacturing process, the method comprising: —
providing object data defining the object, identifying from the object data one or more regions of a surface of the object to be supported during the additive manufacturing process and generating an arrangement of supports for supporting the region taking into account a manner in which the region is already supported.

The method may comprise, for the or each region, identifying one or more supporting structures that will provide support for the region and generating an arrangement of supports within the region, wherein a support location of each support of the arrangement relative to the other supports of the arrangement is derived from a location of the supporting structures.

Accordingly, this method of arranging supports takes into account support that is already provided for the region. Accordingly, supports may be generated that do not duplicate the supporting function of the supporting structures, such as parts of the object that support the region and/or supports for supporting the region, such as edge supports, area supports or user located supports, whose location has already been identified. Such a method may result in a pattern of the supports being dependent on the shape of a perimeter of the region (and, possibly, whether line segments of the perimeter are supported by underlying parts of the object) and/or the location of the edge supports and may result in an irregular pattern of supports across the region.

The arrangement of supports may be generated by identifying an exclusion zone of the region deemed to be supported by a support of the arrangement and identifying a location within the region and outside of the exclusion zone for a further support of the arrangement. The arrangement of supports may be generated by identifying locations for each support of the arrangement in a sequential manner, wherein, for each support, an exclusion zone is determined based upon the locations that have already been identified for supports of the arrangement, and a location for the support is identified within the region and outside of the exclusion zone. Locations for supports in the arrangement may be identified in this manner until one or more termination criteria are met.

An extent of the region may be determined from a line at which a surface of the object is deemed to transition from being self-supporting to non-self-supporting. Whether or not parts of the surface are considered self-supporting may depend on an angle of the surface to the vertical. A line at which the surface transitions from being above or below a preset self-supporting threshold angle to being below or above, respectively, of the self-supporting angle may define a perimeter of the region. In the case wherein the surface is defined by a plurality of polygons, such as triangles, the perimeter may be defined by shared line segments of adjacent polygons wherein, for each line segment, one of the adjacent polygons defines a surface below the self-supporting threshold angle and the other of the adjacent polygons defines a surface above the self-supporting threshold angle. The region may be defined by polygons below the self-supporting threshold angle. The self-supporting threshold angle may be preset by a user and is material dependent. The self-supporting threshold angle may be 45 degrees.

The perimeter of the region may comprise a polyline of unsupported and/or supported line segments. Supported line segments are line segments of a perimeter of the region that are deemed adequately supported during the build by parts of the object that have already been built. Unsupported line segments are line segments of the perimeter of the region that are deemed not adequately supported during the build by parts of the object that have already been built. The method may comprise determining whether a line segment of the perimeter is a supported or unsupported line segment. Determining whether a line segment is or is not adequately supported may comprise an assessment of one or more geometric attributes of the object, which may be dependent on the orientation of the object during the build.

For example, determining whether a line segment is adequately supported may comprise determining if a surface of the part directly below the line segment is at angle to the vertical below a supporting threshold angle, for example below 15 degrees. A supporting threshold angle may be selected by a user and may be material dependent. Even if the angle of the surface is above the supporting threshold angle, the line segment may still be deemed adequately supported if a distance and/or area between the line segment and a surface that is below the supporting threshold angle is below a threshold distance and/or threshold area. This may take into account that short spans of the object that comprise a surface below the supporting threshold angle are self supporting if the span is less than the threshold distance and/or if the area is below the threshold area. Again, threshold distance and/or threshold area may be set by the user and may be material dependent.

Determining whether a line segment of the region is an unsupported line segment may comprise determining if a surface of the part directly below the line segment is deemed not to adequately support the line segment, for example because the surface is at angle to the vertical above the supporting threshold angle.

The method may comprise, for the or each region, identifying one or more unsupported line segments of a perimeter of the region and generating an arrangement of supports, such as an arrangement of edge supports for supporting the one or more line segments, based upon a location of the one or more unsupported line segments. The method may further comprise generating an arrangement of area supports within an area bordered by the edge supports, wherein a location of each area support relative to the other area supports is derived from a position of the supporting structures, including the edge supports.

The method may comprise, for each region, identifying one or more supported line segments of a perimeter of the region and generating an arrangement of supports for supporting the region, the arrangement based upon a location of the or each supported line segment. The locations of edge supports and/or area supports may be based on the location of the supported line segment. The or each arrangement of supports may be determined by spacing each support at least a set distance away from the or each supported line segment. An exclusion zone may be determined based upon a location of the supported line segment and locations for the edge and/or area supports may be identified based on the exclusion zone and preferably, to be outside of the exclusion zone.

The relative location of each support within the arrangement may be either directly or indirectly derived from the locations of the support structures. For example, a relative location of an area support within the arrangement may be determined solely relative to neighbouring area supports but the relative locations of at least one of the neighbouring area supports may have been directly determined, at least in part, from a location of other supporting structures, such as edge supports and/or supported line segments. In this way, the relative location of the area support may be indirectly as well as directly derived from the locations of the support structures. This is different to a preset pattern of supports, wherein the relative locations of the supports within the pattern are preset (even if the absolute location of the pattern may be influenced by the location of edge supports/a perimeter of the region).

The location of each support of the arrangement may be determined from a distance of the support from other supports positioned within the region. A location of the supports may be determined such that no resolved point within the region is further than a preset distance from the supports. Generating an arrangement of supports may comprise, repeatedly, determining a distance of a set of resolved points within the region from locations for supports that have already been identified and identifying a location for a further support at a resolved point based upon the determined distances until one or more termination criteria are met. The one or more termination criteria may comprise the criteria that no resolved point in the region is more than the preset distance away from either a support or a supported line segment. The extent of a region supported by a support can be approximated to be a set distance around the support. Accordingly, by identifying locations for supports based on a distance from other supports allows one to select locations that avoid or reduce duplicating the supporting function provided by the other supports.

It will be understood that “resolved point” means a point on the region for which a distance from a support is determined. The number of resolved points will depend on the resolution set for the analysis. The resolution may be selected by a user. The selected resolution may be a balance between processing speed and accuracy in the placement of the supports.

A grid of nodes (vertex) having a regular pattern, such as a square grid, (at least when viewed from one direction, such as a bird's eye view) may be generated across the region and a distance from a nearest support calculated for each node of the grid. Locating of supports may comprise, repeatedly, locating a support at a node and recalculating the distance from the nearest support for at least the effected nodes. Each support may be located at the node that is the furthest distance from its nearest support. Supports may be generated until the distance of each node from its nearest support is below a threshold value. The threshold value may be set by a user and may be dependent on factors, such as a material to be used to build the object. It will be understood that the distance between the node and the nearest support may not be the distance along the surface of the object but may be a distance between the nodes in a two-dimensional plane, such as a plane parallel with a build plate on which the object is built.

This method of generating supports allows the arrangement of supports to be based on a two-dimensional representation of the region and may result is faster processing than using an algorithm based on a three-dimensional representation of the object. Furthermore, it is not necessary to slice the object into sections in order to determine the locations of the supports, allowing the automatic generation of supports to be decoupled from a slicing operation that determines the layers to be built in an additive manufacturing process.

The method may comprise identifying locations for the edge supports such that the edge supports are arranged in a pattern that corresponds to a shape of the or each unsupported line segment. The method may comprise identifying a location for each edge support such that neighbouring edge supports are located a predetermined distance apart.

An arrangement of edge supports may be generated by identifying locations for the edge supports at or close to a polyline of one or more unsupported line segments. The arrangement of edge supports may be generated by identifying an exclusion zone of the region deemed to be supported by one or more edge supports of the arrangement and identifying a location within the region and outside of the exclusion zone for a further edge support of the arrangement. The arrangement of edge supports may be generated by identifying locations for each edge support of the arrangement in a sequential manner, wherein, for each edge support, an exclusion zone is determined based upon the locations that have already been identified for edge supports of the arrangement, and a location for the edge support is identified within the region and outside of the exclusion zone. Locations for edge supports in the arrangement may be identified in this manner until one or more termination criteria are met. The one or more termination criteria may comprise the exclusion zone of the edge supports encompassing the entire polyline.

The edge supports may be located close enough to the polyline such that the polyline falls within the exclusion zone determined for the edge supports. The exclusion zone may be based on a preset distance set by the user. A location of each edge support may be identified such that a centre of the edge support is inset from the polyline by at least half the thickness of the edge support.

The supports may be “point” supports having a cross-section substantially that of a regular polygon, preferably a circle, at the point the supports meet the region to be supported. Such a support profile may be suitable for area supports as it is believed that such point supports will have adequate strength for supporting these central areas of the region. The edge supports may be point supports, like the area supports, or line supports. The line supports may be straight or may curve, and may have a shape corresponding to the shape of unsupported line segments of the perimeter of the region. Line supports may provide increased strength relative to point supports and may be better at resisting forces exerted on the support due to stresses that arise in the object during the build.

The method may comprise first determining an arrangement of edge supports and then determining an arrangement of area supports based upon the locations identified for the edge supports.

The arrangement of supports determined by the method may be a regular or irregular pattern of supports and will depend on the shape of the region to be supported.

The supports may comprise one or more user located supports. The arrangement of edge supports and/or area supports may be determined taking into consideration a location of user located support(s) and may be determined based on an exclusion zone identified for the user located support(s).

Once an arrangement of supports in the region has been determined, a three-dimensional shape for each support may be generated.

According to a second aspect of the invention there is provided a method of generating geometric data to be used in the building of an object using a layer-by-layer additive manufacturing process, the method comprising providing object data defining the object, slicing the object into sections to be built as layers in the additive manufacturing process, identifying a region of the object to be supported and selecting a site for a support within the region based on a location of an edge of one of the sections that forms at least part of the region.

In this way, supports can be provided taking into account the layered stages of the build and the extent to which each layer overhangs the previous layer.

The geometric data may include a definition of the supports to be built during the additive manufacturing process. The method may comprise defining, in the geometric data, layers of the supports to be successively built in the additive manufacturing process. Accordingly, unlike conventional methods of preparing the geometric data, the layers in the object and layers in the supports are defined in separate processes because the locations of the supports are identified after the layers in the object have been identified. Accordingly, the method may comprise carrying out the following steps in order: receiving object data describing the object, modifying the object data to define the layers of the object to be successively built in the layer-by-layer additive manufacturing process, defining in the data supports for supporting the object based upon the layers of the object defined in the data and defining layers in the supports to be successively built in the layer-by-layer additive manufacturing process.

A site for a support may be determined based upon a distance of an overhanging edge of one of the sections from an edge of a lower section.

It may not be necessary to provide supports for every layer in order to avoid distortions. Accordingly, layers connected to supports (so called “supported layers”) may be distributed among layers that are not connected to supports (so called “unsupported layers”). The number of unsupported layers between supported layers may vary depending on the shape of the part of the object formed by those layers. For example, it may be necessary to provide a greater number of supported layers (and therefore, a fewer number of unsupported layers between the supported layers) for a section of the object that has a downwardly facing surface at a smaller angle to the horizontal during the build than a section having a downwardly facing surface at a steeper angle to the horizontal during the build. Accordingly, the number of unsupported layers between supported layers may be selected based upon an angle of inclination to the horizontal during the build of a downwardly facing surface formed by these layers. The method may comprise identifying locations of supports only for downwardly facing surfaces that are below a threshold angle to the horizontal.

According to a third aspect of the invention there is provided apparatus comprising a processing unit arranged to carry out the method of the first or second aspect of the invention.

The processor may be part of an additive manufacturing machine.

According to a fourth aspect of the invention there is provided a data carrier having stored thereon instructions, which, when executed by a processor, cause the processor to carry out the method of the first or second aspect of the invention.

The data carrier of the above aspects of the invention may be a suitable medium for providing a machine with instructions such as non-transient data carrier, for example a floppy disk, a CD ROM, a DVD ROM/RAM (including −R/−RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example a signals sent over a wired or wireless network (such as an Internet download, an FTP transfer, or the like).

According to a fifth aspect of the invention there is provided a method of building an object comprising generating geometric data by carrying out the method of the first or second aspect of the invention and then building an object using an additive manufacturing process based on the geometric data.

According to a sixth aspect of the invention there is provided a three-dimensional object manufactured in accordance with the fifth aspect of the invention.

According a seventh aspect of the invention there is provided a three-dimensional object connected to a base plate via supports manufactured in accordance with the fifth aspect of the invention.

### DESCRIPTION OF THE DRAWINGS

FIGS. 1 to 3 are examples of support arrangements generated in accordance with a prior art method;

FIG. 4 shows an additive manufacturing machine according to an embodiment of the invention;

FIG. 5 is a cross-section of an object to be built showing regions that do not require support and regions that do require support as defined in accordance with the invention;

FIG. 6 is a perspective view of an object defined by a series of tessellated triangles with regions that require support shaded to aid identification;

FIG. 7 shows a plan view of a region requiring support and a schematic representation of the placement of edge supports around the region in accordance with an embodiment of the invention;

FIGS. 8 to 13 show a progression in the generation of an arrangement of area supports in accordance with an embodiment of the invention;

FIG. 14 is a flowchart showing a method of identifying locations for supports according to one embodiment of the invention; and

FIG. 15 is a cross-section of an object showing schematically how a location of supports is identified in accordance with another embodiment of the invention.

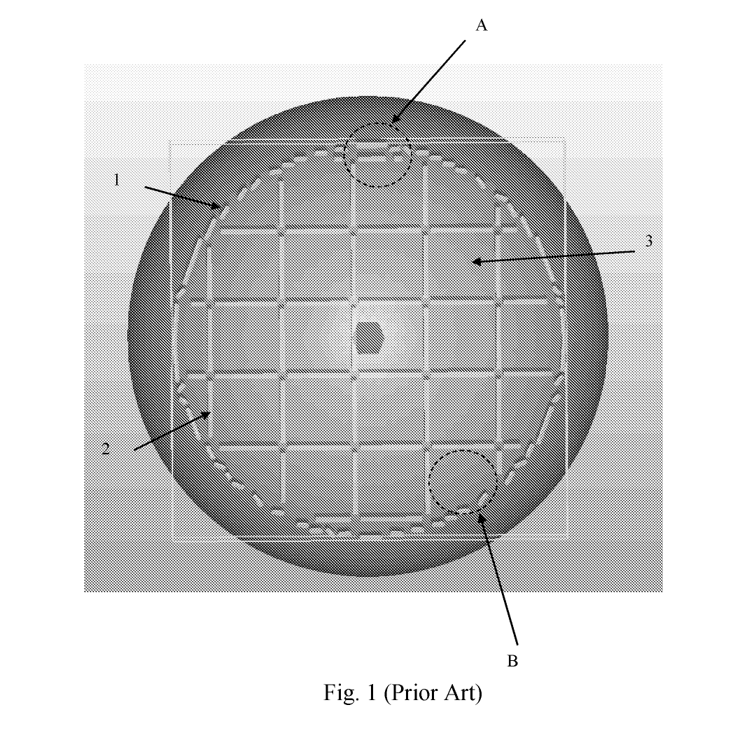

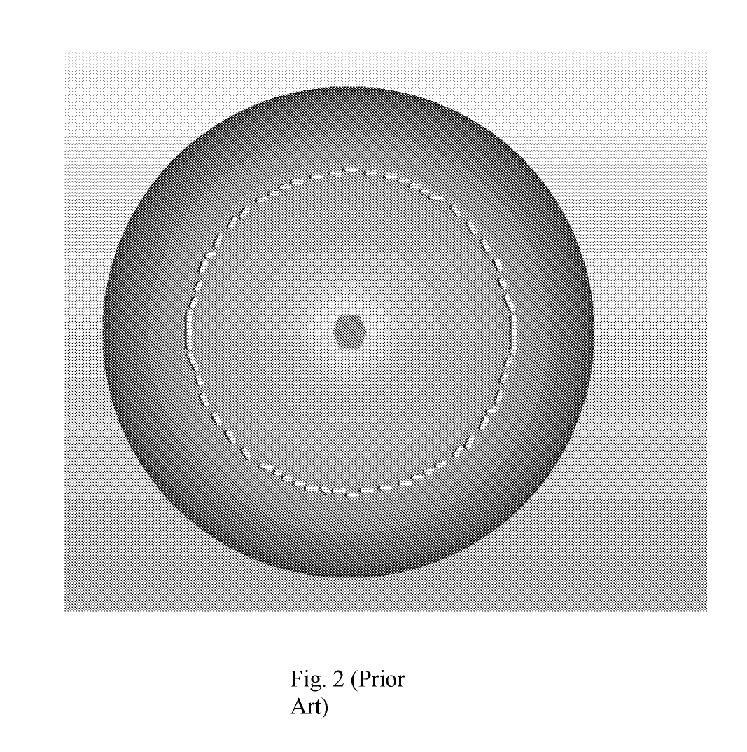

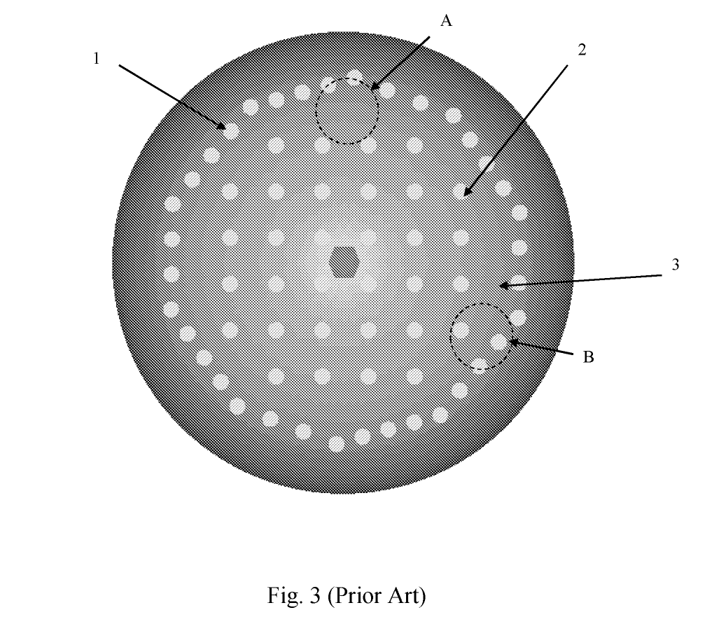

### DESCRIPTION OF EMBODIMENTS

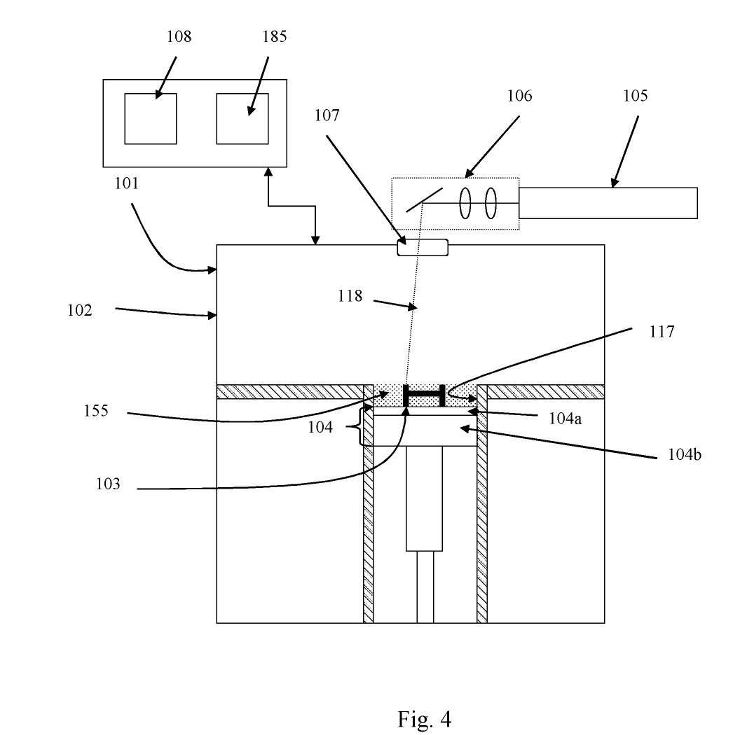

FIG. 4 illustrates a typical selective laser melting apparatus 101. The apparatus defines a build chamber 102 within which a three-dimensional component 103 is produced, and comprises a lowerable build platform 104 on which the three-dimensional component 103 is supported. The build chamber 102 also houses a powder dispensing and coating apparatus (not shown) for spreading layers of powder 155 over the surface of the build platform. An optical module 106 (either housed within or outside the build chamber) comprises steerable optics for delivering a laser beam 118 generated by a laser 105 to selected locations on a powder layer for consolidating the powder at these locations in order to build the object. The build platform 104 is arranged to be lowerable within the bore of a build cylinder 117, which allows the surface of the top powder layer to remain in substantially the same plane within the machine while the object 103 is built up from successive powder layers. The build platform 104 incorporates both a build-support 104b and a build plate 104a, which is removably securable to the build-support 104b, to which the object 103 can be anchored during its formation.

The apparatus further comprises a processor 108 for controlling the steerable optics in the optical module 106, the laser 105, the powder dispensing and spreading apparatus and lowering of the build platform. The processor 108 controls the optics based upon geometric data stored in memory 185 such that an article (object plus supports) is built in accordance with that described in the geometric data. Accordingly, the geometric data comprises data on the object to be built and supports to be built alongside the object, the supports preventing distortions of the object during the build. The geometric data also defines the consolidated layers to be built at each stage of the additive manufacturing process in order to form the object and supports. This geometric data may be uploaded from an appropriate source, such as a computer, memory stick or the like.

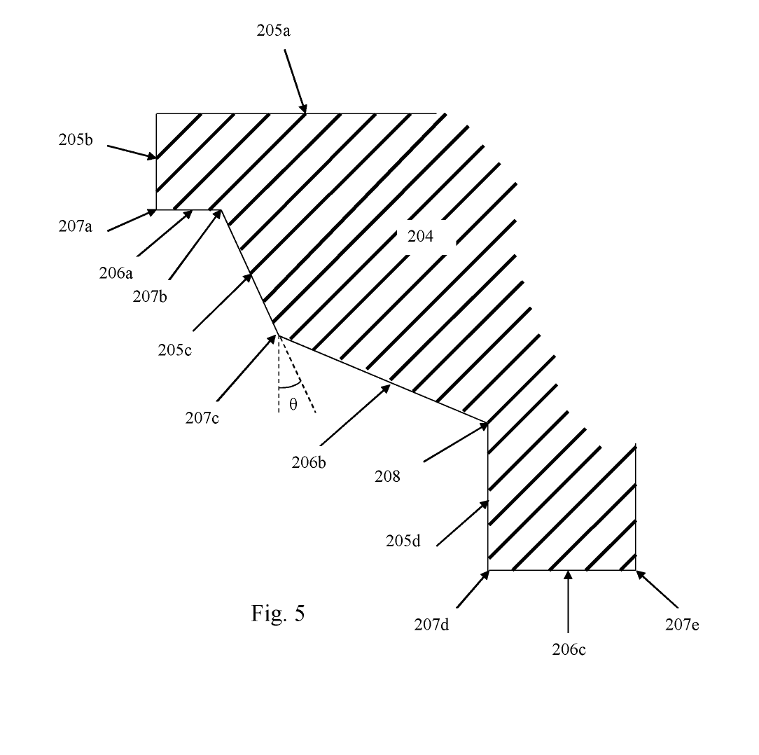

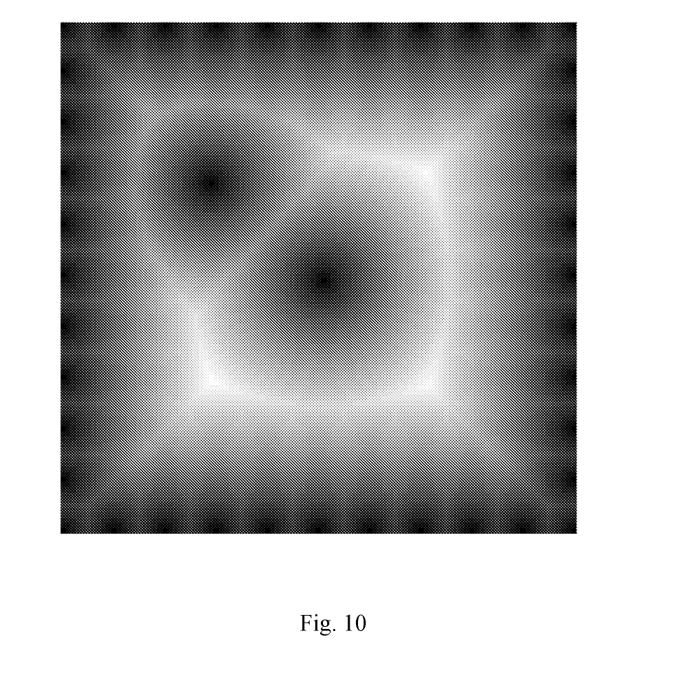

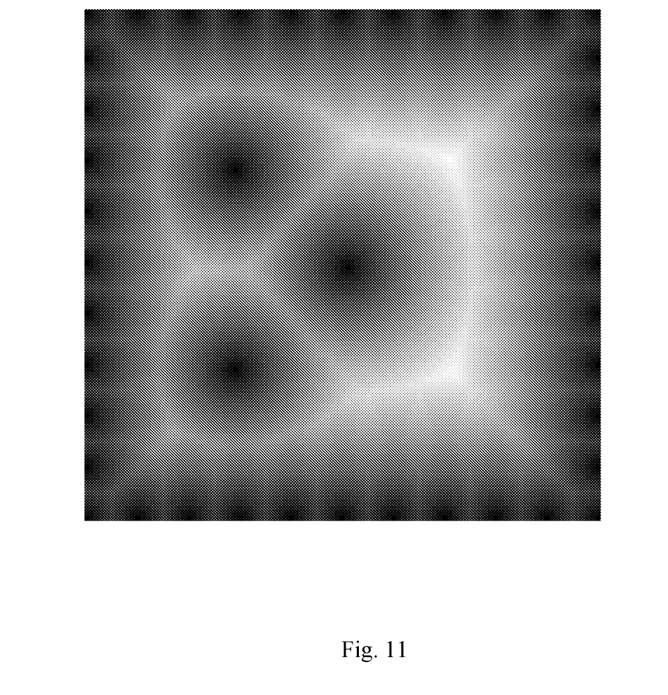

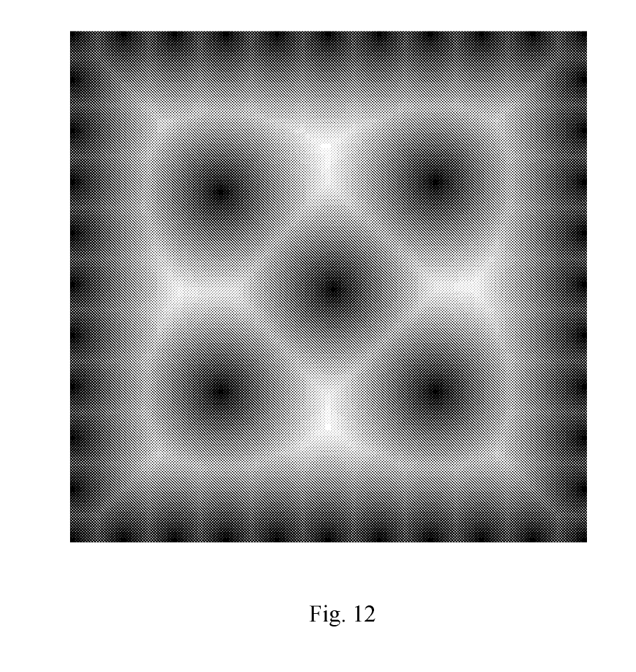

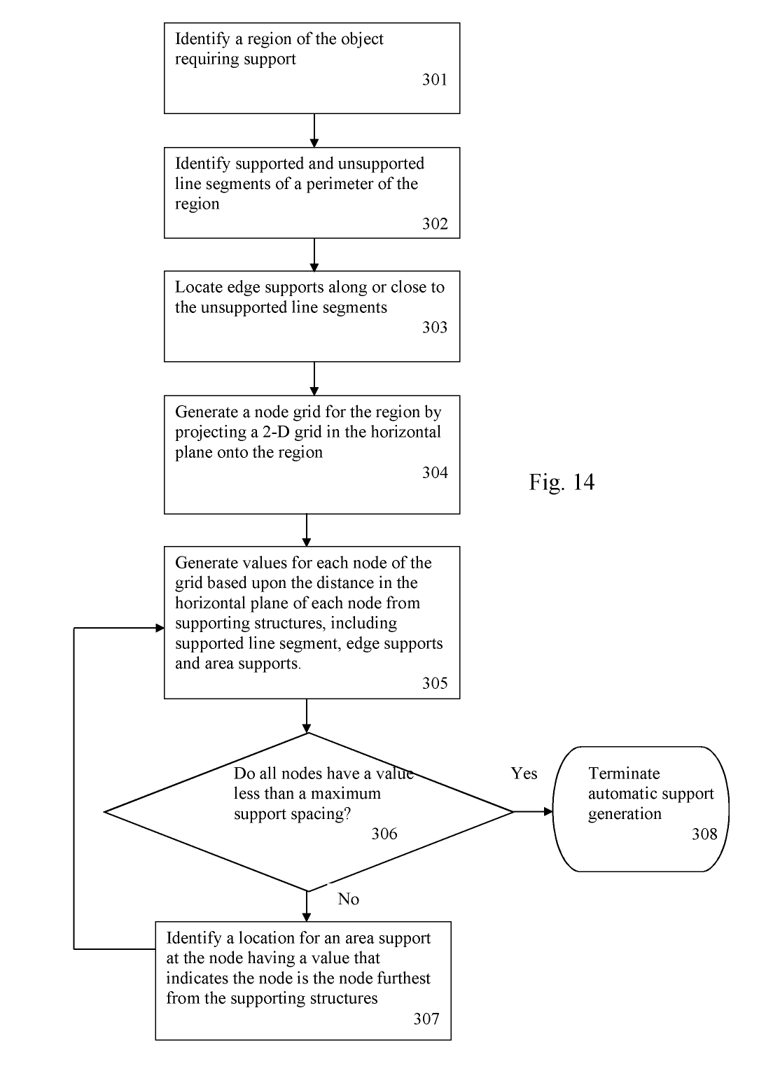

Now referring to FIGS. 5 to 14, a method of generating the geometric data in accordance with an embodiment of the invention will be described. Object data is provided, such as a 3-dimensional representation on the object in a CAD data format imported from an external source. The CAD data may be converted into a data format, such as Standard Tessellation Language (STL), which describes only the surface geometry of the object as a set of tessellated triangles without other properties of the object that may be described in the CAD data, such as colour, texture, etc.

A user or the computer then orients the object with respect to a desired build direction. The selection of the orientation may depend on a number of factors, such as minimising stresses that may occur during the build and the time of the build. Often the orientation will be a compromise between opposing factors.

After orientation of the object, supports for supporting downwardly facing surfaces of the object during the build may be designed. The locations of the supports may be carried out in a fully automated manner or may combine automatic and manual identification of locations for the supports.

To automatically generate supports 106, the computer first identifies 301 self-supporting regions of the object that are deemed not to require the addition of supports and non-self-supporting regions of the object that are deemed to require the addition of supports during the selective laser melting process in order to prevent distortions of the region during the build. Whether or not a region is deemed self-supporting may depend on parameters set by the user and may differ for different builds. For example, whether or not a region is self-supporting may depend on parameters such as material used for the build, laser power, exposure time, spot distance, scan speed and spot diameter. However, in this embodiment, the user sets a self-supporting threshold angle to the vertical below which a region is considered self-supporting. For example, an angle of 45 degrees may be selected for the self-supporting threshold angle.

FIG. 5 shows a cross-section of an object 204 comprising supported regions 205a to 205d and unsupported regions 206a to 206c. The extent (perimeter) of an unsupported region 206a to 206c is defined by a line at which the surface transitions from being at an angle below the self-supporting threshold angle to an angle above the self-supporting threshold angle. For example, in FIG. 5, threshold points 207a to 207e and 208 are shown.

Once regions to be supported have been identified, it is determined whether line segments that form a perimeter of each region are adequately supported (so called “supported line segments”) by parts of the object below these line segments. In this embodiment, line segments are identified as supported line segments if a surface immediately below the line segment is at an angle to the vertical below a supporting threshold angle. The supporting threshold angle may be set by the user and is material dependent. For example, the supporting threshold angle will typically be around 15 degrees.

Threshold points 207a to 207e are points along unsupported line segments as the surfaces 206a, 205c, 206b and 206c are at an angle to the vertical above the supporting threshold angle, whereas point 208 is a point along a supported line segment as the surface 205d is at an angle to the vertical less than the supporting threshold angle.

As illustrated in FIG. 5, because of the double angle criteria, it is possible to have a region 205c that does not require support but is deemed not to provide support for points, such as 207b, because the surface 205c is at an angle, θ, below the self-supporting angle threshold but above the supporting angle threshold.

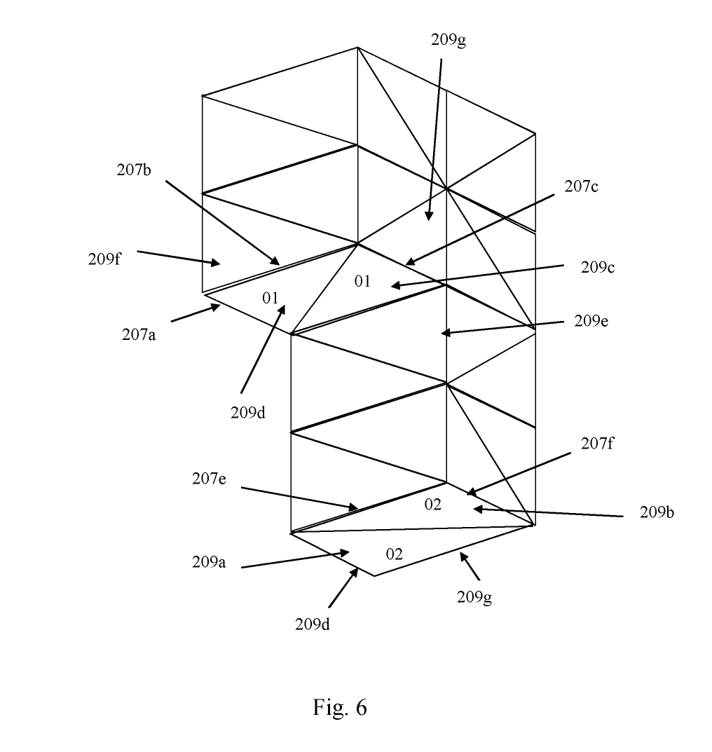

Referring to FIG. 6, in this embodiment, the non-self-supporting regions are identified from the triangles 209 used to define the object. The algorithm searches through the triangles 209 for a triangle 209a to 209d, which violates the self-supporting angle threshold (for example, this may be carried out by looking at an angle of a normal to the triangle to the vertical). A triangle, such as 209d, that violates the angle criteria is marked with a region ID, indicated by 01 and 02 in FIG. 6. Once a triangle 209c has been found that violates the angle criteria, the neighbouring triangles are checked to determine if they also violate the angle criteria. If a neighbouring triangle, such as 209c, does violate the angle criteria, the triangle is marked with the same region ID. This process is repeated until all neighbouring triangles of the region are found to meet the angle criteria. For example, the region 01 only extends as far as triangles 209c and 209d because the four neighbouring triangles (of which three, 209e to 209g, are shown) meet the angle criteria. The remaining triangles 209 are searched and if further triangles, such as 209a and 209b, are found that violate the angle criteria these are marked with a different region ID, such as 02. The process is terminated when all triangles 209 have been checked.

Each disparate region 01, 02 is a region for which supports are to be generated.

In step 302, line segments 207a, 207b, 207c and 208 of each region 01, 02 are identified. A perimeter of a region requiring support is a closed polyline of the line segments 207a, 207b, 207c and 208 that run along triangle edges that define the region. Once the line segments 207a, 207b, 207c and 208 have been found, for each line segment 207a, 207b, 207c and 208 it is determined whether the line segment is a supported 208 or unsupported line segment 207a, 207b, 207c. This determination is made by identifying the neighbouring triangle 209e, 209f, 209g that shares the line segment but is not part of the region and identifying if the neighbouring triangle is below the triangle with which it shares the line segment and if a plane of the triangle is at an angle to the vertical below the supporting threshold angle. So, in FIG. 6, triangle 209e is deemed a supporting triangle for line segment 208 whereas triangles 209f and 209 g are not supporting triangles for line segments 207a, 207b, 207c. Accordingly, line segment 208 is determined to be a supported line segment whereas line segments 207a, 207b and 207c are deemed to be unsupported line segments. Using the same analysis, line segments 207d to 207g of region 02 are all determined to be unsupported line segments.

As can be understood from the description above, a surface that does not require support does not necessarily provide sufficient support for surfaces above. For this reason there are separate angle criteria for determining whether a region requires support and whether line segments of a perimeter of the region are adequately supported.

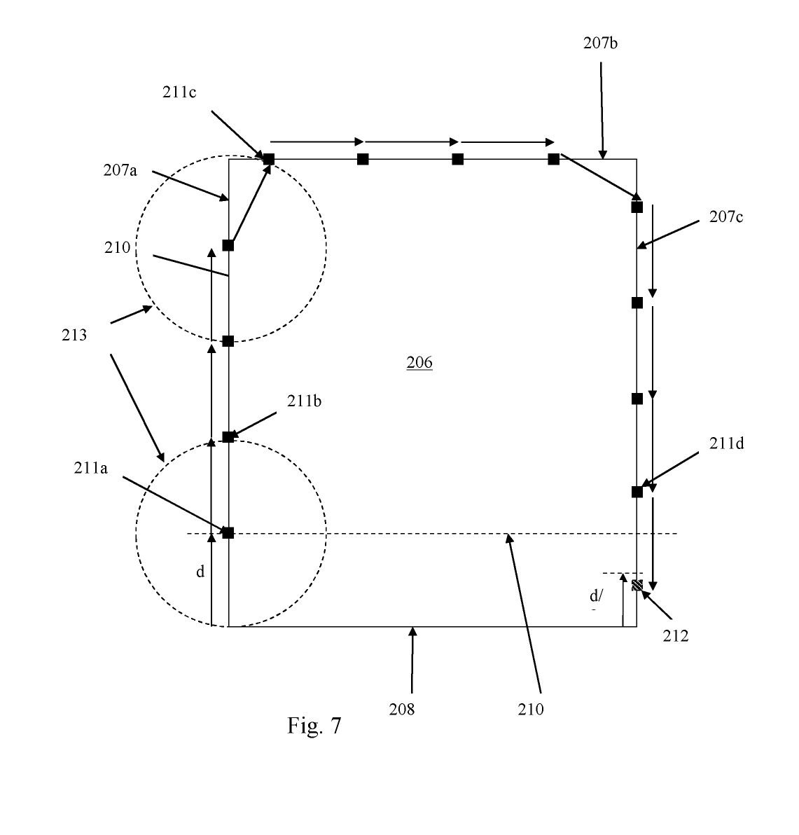

A method for generating an arrangement of edge supports for a region will now be described with reference to FIG. 7. Locations for edge supports 211 are identified 303 for each polyline formed by unsupported line segments 207. The locations for the edge support are identified based upon the location of the unsupported line segments 207 and a given set spacing, d, for the edge supports. The set spacing, d, may be defined by a user. The edge supports are also located a set distance, such as the set spacing d from any supported line segment 208.

First an exclusion zone/region 210 is determined for the region 206 based on a location of a/each supported line segment 208 of the region 206. The exclusion zone is an area of the region 206 that is within distance, d, of the supported line segment. Distance, d, may be measured in a horizontal plane rather than along the surface of the region. A location for a first edge support 211a is identified on or slightly inset from an unsupported line segment 207a at the edge of the exclusion zone 210 when moving in a direction (as indicated by the arrows) along a polyline of the unsupported line segments 207. The direction of progression along the polyline is based on a “winding order” specifying a location of the region (either left or right) relative to the direction of progression. In this embodiment, the winding order is to maintain the region to the right.

An exclusion zone 213 is generated for that edge support 211a and a location for a further edge support 211b is identified along or slightly inset from the unsupported line segment 207a at the edge of this exclusion zone 213 as one continues to move in the specified winding direction along the polyline of unsupported line segments 207. The location for edge supports 211 continue to be identified in this manner along the polyline formed by the unsupported line segments 207a, 207b, 207c. As can be seen from edge support 211c, the spacing between the edge supports is based on a 2-dimensional point distance not the distance along the polyline. In this way, an appropriate density of edge supports is achieved.

The spacing between the final edge support and a supported line segment (in the case of an open polyline of unsupported line segments) or the spacing between the final and first edge support (in the case of a closed polyline of unsupported line segments) may not be that of the set spacing d. In this embodiment, if it is determined that the next edge support 212 would to be located within 0.5d of the supported line segment 208/first edge support 211a, it is decided that an edge support 212 should not be provided at this location and the algorithm for determining locations for edge supports along this polyline is terminated. However, if an identified location for edge support 212 is further than 0.5d from the supported line segment/first edge support then this location is identified as suitable for the edge support 212. Accordingly, the final edge support of the polyline may be located within 0.5d to 1.5d of the supported line segment/first edge support.

The locations for edge supports are determined in this manner for all polylines of unsupported line segments 207.

Each edge support 211 is also given an orientation for offsetting and aligning directional supports. In this embodiment, for a given edge support location, the orientation is the cross-product of the vertical z-axis and the line connecting the two neighbouring edge supports. The support is offset and/or aligned based on the determined orientation. Each edge support may be offset from the unsupported line segment by a radius of the edge support where is meets the object. The radius/width of each support where the support meets the object may be smaller than the radius/width lower down the support as the support may taper towards the end proximal to the object to provide a weakened/frangible portion that can be more easily broken when removing the supports from the object.

The user may also generate further edge supports through manual identification of a location if the user deems this appropriate/required.

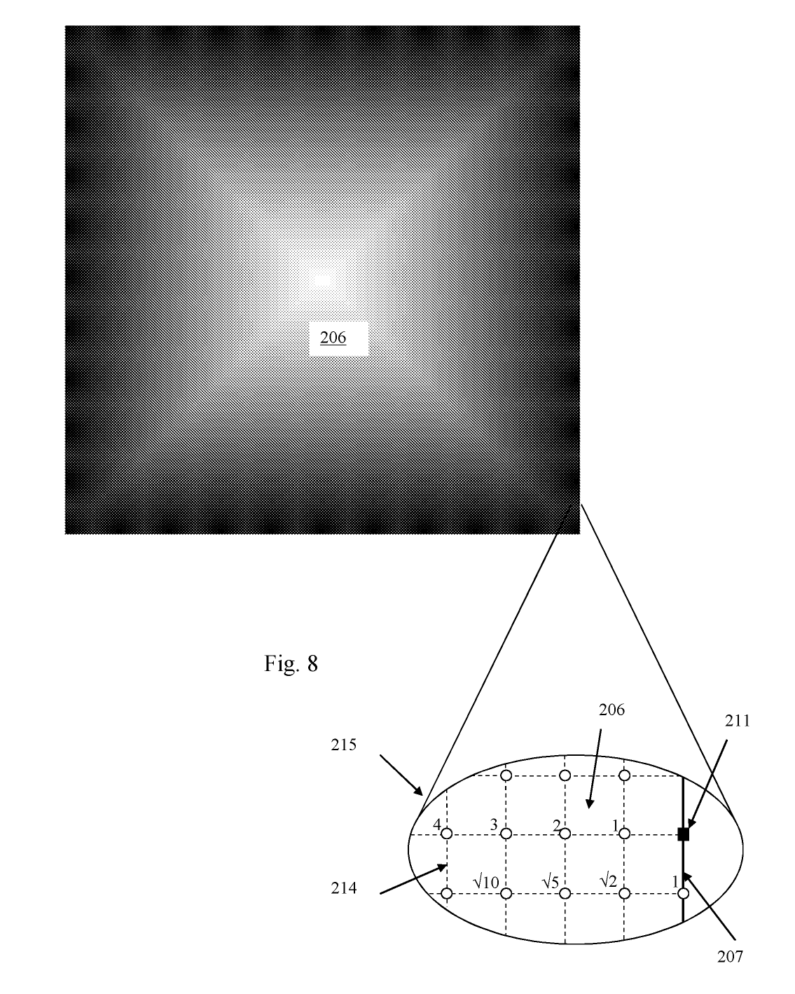

Referring to FIGS. 8 to 13, once the locations of the edge supports 211 have been identified, a node grid 214 is generated 304 across each unsupported surface 206 (this is most clearly shown in the magnified section 215 in FIG. 8). The node grid is a projection of a 2-D grid in the horizontal plane onto the unsupported surface 206. Accordingly, the distance between node points on the surface may be different to the distance between the node points in the horizontal plane depending on the angle of the surface to the horizontal. Determining the location of area supports based upon a 2-dimensional grid simplifies processing compared to processing in 3-dimensional space.

In step 305, values are generated for each node based on a distance the node is from supporting structures, such as the supported line segments 208 that border the region 206 and the edge supports 211 whose locations have already been identified on the region 206. In FIG. 8, no supported line segments are shown. The magnified section in FIG. 8 illustrates a location 211 of an edge support and the values calculated for each node based on the distance of the node from the edge support 211. The unmagnified section of FIG. 8 illustrates the values given to the nodes as a heat map across the unsupported surface, wherein light colours identify “hot” areas a long way from a support and dark areas identify “cold” areas closer to a support.

Once a value for each node has been determined, it is determined 306 if any node has a value above a maximum permissible spacing (defining an exclusion zone) between a node and support. The maximum permissible spacing may be set by the user and may be derived from the set spacing, d, specified for the edge supports.

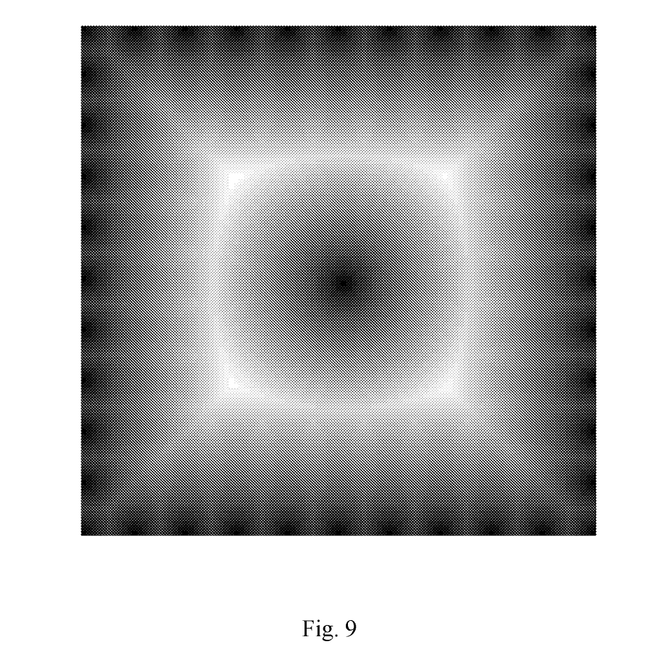

For example, the maximum permissible spacing may be d/2. If one or more nodes have a value that is greater than the maximum permissible spacing, a location for an area support is specified 307 at the node having the greatest distance from the existing supports and, if present, supporting line segment(s). Such as step is shown in FIG. 9, wherein a location for an area support is identified in the centre of the unsupported surface and the heat map of FIG. 9 shows the re-determined values for the nodes based on locating an area support at this location.

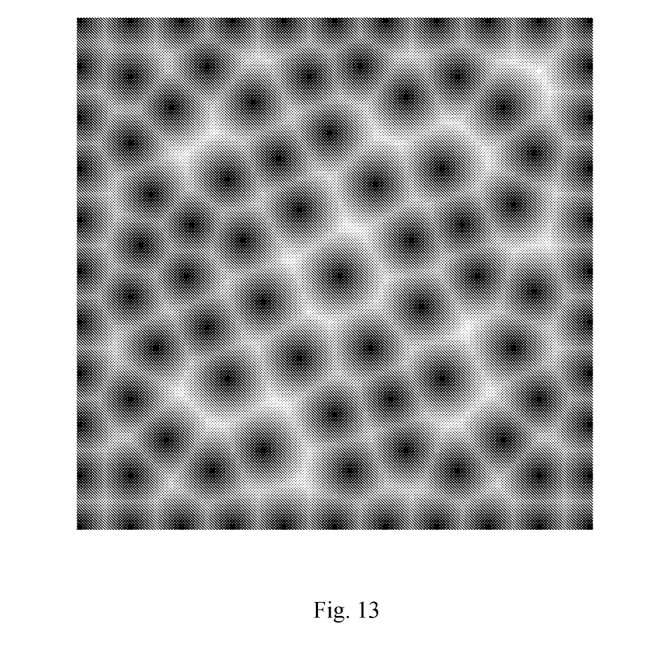

These steps are repeated until all nodes have a value below the maximum permissible distance. At this point the algorithm is terminated 308. FIGS. 9 to 13 illustrate the progression of the algorithm with the locations for area supports being identified and values for the nodes recalculated based on the newly identified locations for supports. (It should be noted that the temperature scale changes for each FIGS. 9 to 13). As can be seen from FIG. 13, the spacing between each area support and its neighbouring area supports is approximately the same with no area support being located much closer or much farther away from other supports such that each support provides a comparable supporting function. In this way, redundant support or too little support is avoided.

The node width can be altered by selection of the node width by the user. Selecting a smaller node width may increase accuracy of placement of the area supports, whereas selection of a larger node width may increase a processing speed in which locations of the area supports are determined. In this embodiment, the user is limited to selecting a node width that is less than the maximum spacing between a node and a support, such as 50% or less and preferably, 10% or less of the node spacing.

For both edge and area supports, the location (a termination point) of an end of the support distal from the surface 206 that is supported is determined by projecting the support downwards in the vertical z-direction until it either meets another part of the object or the base plate. However, it will be appreciated that rather than vertical supports, other support structures could be used, such as consolidating the supports into a tree structure, such as described in U.S. Pat. No. 5,595,703

Once the supports have been designed, the supports may be sliced to define layers to be built during the additive manufacturing process and a scan path determined for each slice. The geometric data is then transferred to the memory 185 of the additive manufacturing apparatus 100. During a build, the processor 108 on the apparatus reads the instructions and controls the laser 105 and optics 106 appropriately to build an object and supports in a layer-by-layer manner in accordance with the scan paths defined in the geometric data.

After the build, the object is removed from the machine and the supports cut-away from the object.

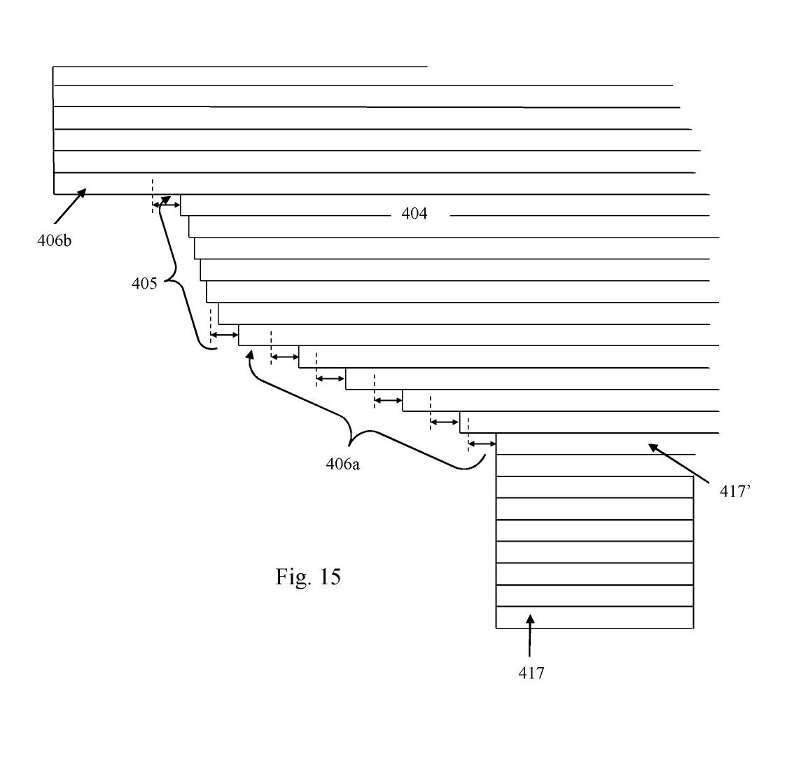

A further embodiment of the invention will now be described with reference to FIG. 15. In FIG. 15, whether or not a region of the object is to be supported is based on the layers (slices) 417 determined for an object. During processing of an STL file describing an object into instructions to drive an additive manufacturing machine, successive layers 417 to be solidified during the additive manufacturing process are determined from the geometric object described in the STL file. For each overhanging layer 417′, a distance, L, from an overhanging edge of the layer 417′ to the edge of layer below is determined. If the distance, L, is greater than a threshold distance (indicated by the arrows in FIG. 15) then the layer 417′ is identified as a layer 417′ that requires support. In FIG. 15, the overhangs of layers 406a and 406b meet the criteria for the provision of supports whereas layers 405 do not meet the criteria. Supports may then be designed for each layer 417′ in accordance with the method described above with respect to the first embodiment. Supports may be determined for each layer 417′ individually or the layers 417′ may be grouped together into a region, such as the layers grouped as 406a, the supports determined for a region defined by the group. This method may avoid large unsupported areas being present during the build, which could occur of the layered structure is not taken into account when locating supports.

Alterations and modifications may be made to the above described embodiments without departing from the invention as defined herein. For example, the node grid may comprise another regular tiling, such as a triangular or hexagonal grid.

1. A method of generating geometric data to be used in the building of an object using a layer-by-layer additive manufacturing process, the method comprising: —
providing object data defining the object, identifying from the object data one or more regions of a surface of the object to be supported during the additive manufacturing process; and
for the or each region, identifying one or more supporting structures that will provide support for the region, generating an arrangement of supports within the region, wherein a support location of each support of the arrangement relative to the other supports of the arrangement is derived from a location of the supporting structures.

2. A method according to claim 1, wherein the relative location of each support within the arrangement is either directly or indirectly derived from the locations of the one or more supporting structures.

3. A method according to claim 2, wherein the location of each support of the arrangement is determined from a distance of the support from other supports positioned within the region.

4. A method according to claim 2, wherein a location of each support of the arrangement is determined such that the support is outside of a preset distance from neighbouring supports.

5. A method according to claim 1, wherein generating an arrangement of supports comprises, repeatedly, determining a distance of a set of resolved points within the region from the support locations that have already been identified and identifying a location for a further support of the arrangement at a resolved point based upon the determined distances until one or more termination criteria are met.

6. A method according to claim 5, wherein the one or more termination criteria comprises the criteria that no resolved point in the region is more than a preset distance away from one of the supports or the one or more support structures.

7. A method according to claim 1, comprising, for each region, identifying one or more unsupported line segments of a perimeter of the region and identifying locations for an arrangement of edge supports based on the location of the unsupported line segments.

8. A method according to claim 7, wherein the edge supports are arranged in a pattern that corresponds to a shape of the or each unsupported line segment.

9. A method according to claim 8 comprising identifying a location for each edge support such that neighbouring edge supports are located a predetermined distance apart.

10. A method of generating geometric data to be used in the building of an object using a layer-by-layer additive manufacturing process, the method comprising: —
providing object data defining the object, identifying from the object data one or more regions of a surface of the object to be supported during the additive manufacturing process; and
for the or each region, generating an arrangement of supports, wherein generating an arrangement of supports comprises identifying an exclusion zone of the region deemed to be supported by a support of the arrangement and identifying a location within the region and outside of the exclusion zone for a further support of the arrangement.

11. A method according to claim 10, wherein the arrangement of supports is generated by identifying locations for each support of the arrangement in a sequential manner, wherein, for each support, an exclusion zone is determined based upon the locations that have already been identified for supports of the arrangement, and a location for the support is identified within the region and outside of the exclusion zone.

12. A method according to claim 10, wherein the arrangement of supports is an arrangement of edge supports whose locations are identified at or close to a polyline of one or more unsupported line segments of a perimeter of the region.

13. A method according to claim 12, wherein the edge supports are located close enough to the polyline such that the polyline falls within the exclusion zone of the edge supports.

14. A method according to claim 13, wherein a location of each edge support is identified such that a centre of the edge support is inset from one unsupported line segment by at least half the thickness of the support.

15. A method according to claim 1, comprising, for each region, identifying one or more supported line segments of a perimeter of the region, wherein the arrangement of supports is based upon a location of the or each supported line segment.

16. A method of generating geometric data to be used in the building of an object using a layer-by-layer additive manufacturing process, the method comprising: —
providing object data defining the object, identifying from the object data one or more regions of a surface of the object to be supported during the additive manufacturing process; and
for each region, identifying one or more supported line segments of a perimeter of the region and generating an arrangement of supports for supporting the region, the arrangement based upon a location of the or each supported line segment.

17. A method according to claim 16, wherein the or each arrangement of supports is determined by spacing each support at least a set distance away from the or each supported line segment.

18. A method according to claim 1, wherein identifying a region to be supported comprises identifying a region having a perimeter at which a surface of the object transitions from being above a preset self-supporting threshold angle to being below the self-supporting angle.

19. A method according to claim 1, wherein determining whether a line segment of the region is an unsupported or supported line segment comprises determining if a surface of the part directly below the line segment is at angle to the vertical below a supporting threshold angle.

20. A data carrier having stored thereon instructions, which, when executed by a processor, cause the processor to carry out the method of claim 1.
